(19) United States
(12) Patent Application Publication
(10) Pub. No.: US 2013/0261240 A1
(43) Pub. Date: Oct. 3, 2013

(54) POLYURETHANE RESIN POWDER COMPOSITION FOR SLUSH MOLDING

(71) Applicants: SANYO CHEMICAL INDUSTRIES, LTD., Kyoto-shi (JP); CALSONIC KANSEI CORPORATION, Saitama-shi (JP)

(72) Inventors: Shu Yasuhara, Kyoto-shi (JP); Yasuhiro Tsudo, Kyoto-shi (JP); Koichi Saito, Kyoto-shi (JP); Masaaki Namiki, Saitama-shi (JP); Naohito Jinnai, Saitama-shi (JP); Shigeji Ichikawa, Saitama-shi (JP); Masaaki Tamura, Saitama-shi (JP)

(73) Assignees: CALSONIC KANSEI CORPORATION, Saitama-shi (JP); SANYO CHEMICAL INDUSTRIES, LTD., Kyoto-shi (JP)

(21) Appl. No.: 13/793,179

(22) Filed: Mar. 11, 2013

(30) Foreign Application Priority Data
Mar. 30, 2012 (JP) 2012/078852

(51) Int. Cl. C08L 33/12; C08L 75/04

(52) U.S. Cl. CPC C08L 33/12; C08L 75/04
USPC 524/292

(57) ABSTRACT

Provided is a polyurethane resin powder composition for slush molding from which an outer skin for an instrument panel can be produced, the outer skin not interfering with deployment of an airbag. More specifically, provided is a polyurethane resin powder composition (D) for slush molding comprising perfectly spherical thermoplastic polyurethane resin particles (A) obtained by reacting a polyester diol component (J) and a diisocyanate component (F), a plasticizer (B), and a vinyl-type copolymer fine particles (C) having a crosslinked structure, wherein the polyester diol component (J) comprises a polyester diol (J1) comprising an aromatic dicarboxylic acid (E) and ethylene glycol as essential constituent units, a ratio of volume average particle sizes of (A) and (C), (A):(C), is 200:1 to 2000:1, and an extent of surface coverage of a surface of (A) with (C) {Equation (1)} is 20 to 80%.

[Expression 1]

Extent of surface coverage (%)=[number of particles of (C)]×[average cross section area of one particle of (C)]/surface area of (A)×100 (1)

### TECHNICAL FIELD

The present invention relates to a polyurethane resin powder composition for slush molding.

### BACKGROUND ART

In recent years, a thermoplastic polyurethane resin is being used for an instrument panel which is an automotive interior component, because the resin makes it possible to mold a product with a complex shape easily, to obtain uniform wall thickness, and to realize a good yield rate of material. In order to deploy an airbag stored under the instrument panel, a rupture opening is provided on the instrument panel. Fabrication of the rupture opening is carried out, from the standpoint of design characteristics, by a method of cutting a slit on the rear side of the instrument panel by means of a hot knife (Patent Literature Nos. 1 and 2).

### PRIOR ART DOCUMENTS

### Patent Documents

Patent Document 1: Japanese Patent Application Laid-Open (JP-A) No. H8-282420

Patent Document 2: JP-A No. 2000-280847

### SUMMARY OF THE INVENTION

### Problems to be Solved by the Invention

When the polyurethane resin powder composition for slush molding is molded into an instrument panel, it is known that, if a degree of tensile elongation of an outer skin of the instrument panel is 600% or more, there is a fear that, at the time of airbag deployment, the pressure to open the airbag is consumed in elongation of the outer skin and, depending on the situation, the airbag does not deploy. Further, although as a method to suppress the elongation, there can be mentioned a method where the elongation is controlled by making a fracture point by adding inorganic fine particles, which do not dissolve at the temperature of slush molding, to the outer skin, this method is known to result in lower resin strength and occurrence of a trouble that, at the time of airbag deployment, the instrument panel ruptures at a position other than the rupture opening.

The problem which the present invention tries to solve is to provide a polyurethane resin powder composition for slush molding, which makes it possible to produce an outer skin for an instrument panel, the outer skin having a degree of tensile elongation of less than 600%, being free from a trouble that the resin is weak and, at the time of airbag deployment, the instrument panel ruptures at a position other than the rupture opening, and thus not interfering with deployment of an airbag.

### Means for Solving the Problems

The present inventors conducted diligent research and, as a result, reached completion of the present invention. The present invention is a polyurethane resin powder composition (D) for slush molding comprising perfectly spherical thermoplastic polyurethane resin particles (A) obtained by reacting a polyester diol component (J) and a diisocyanate component (F), a plasticizer (B), and vinyl-type copolymer fine particles (C) having a crosslinked structure, wherein the polyester diol component (J) comprises a polyester diol (J1) comprising an aromatic dicarboxylic acid (E) and ethylene glycol as essential constituent units, a ratio of volume average particle sizes of (A) and (C), (A):(C), is 200:1 to 2,000:1, and an extent of surface coverage of the surface of (A) with (C) {Equation (1)} is 20 to 80%; a polyurethane resin molded article obtained by molding the composition (D); and a process for producing the composition (D).

$$\begin{matrix} [ Expression 1 ] & \\ Extent of surface coverage ( \% ) = \frac{\begin{matrix}[ number of particles of ( C ) ] \times \\ [ average cross section area of one particle of ( C ) ]\end{matrix}}{surface area of ( A )} \times 100 & ( 1 )\end{matrix}$$

[In the above-described Equation (1), the number of particles of (C) is calculated by dividing an additive amount (weight) of (C) by a product of an average volume of one particle of (C), obtained as described below, and true specific gravity of (C). The average volume of one particle of (C) and the average cross section area of one particle of (C) are calculated from a radius of a primary particle of (C), the radius being determined by observing (C), which has been crushed to primary particles, with a scanning electron microscope. The surface area of (A) is obtained by dividing a particle size distribution obtained by a particle size analyzer into 30 to 60 sections, calculating the surface areas of (A) for respective divided sections from a particle size and a frequency obtained from a center value of distribution for each divided section, and calculating the surface area of (A) from a sum of these surface areas.

### Effects of the Invention

The outer skin for the instrument panel, obtained by slush molding the polyurethane resin powder composition (D) for slush molding of the present invention, has a degree of tensile elongation of less than 600%. It is also free from a trouble that the resin strength is low and, at the time of airbag deployment, the instrument panel ruptures at a position other than the rupture opening and has excellent airbag deployment performance.

### MODE FOR CARRYING OUT THE INVENTION

The polyurethane resin powder composition (D) for slush molding of the present invention comprises perfectly spherical thermoplastic polyurethane resin particles (A) obtained by reacting a polyester diol component (J) and a diisocyanate component (F), a plasticizer (B), and a vinyl-type copolymer fine particles (C) having a crosslinked structure.

The thermoplastic polyurethane resin which constitutes the perfectly spherical thermoplastic polyurethane resin particles (A) is obtained by reacting a polyester diol component (J) and a diisocyanate component (F).

The polyester diol component (J) comprises a polyester diol (J1) comprising an aromatic dicarboxylic acid (E) and ethylene glycol as essential constituent units.

The polyester diol (J1) is obtained by reacting ethylene glycol and an aromatic dicarboxylic acid (E) as essential components. The polyester diol (JI) can be obtained by a dehydration condensation reaction of ethylene glycol and an aromatic dicarboxylic acid (E) or by a reaction of ethylene glycol and an ester-forming derivative of (E) [acid anhydrides (phthalic anhydride and the like), lower alkyl esters (dimethyl terephthalate, dimethyl isophthalate, dimethyl orthophthalate, and the like), and acid halides (phthalic acid chloride and the like)].

The aromatic dicarboxylic acid (E) includes isophthalic acid, terephthalic acid, orthophthalic acid, and the like. The dicarboxylic acid (E) may be a single component or a combination of two or more components.

Among the polyester diols (J1), preferable ones from the standpoint of handling include, for example, a polyester diol composed of ethylene glycol and terephthalic acid/isophthalic acid (=50/50 by molar ratio), a polyester diol composed of ethylene glycol and terephthalic acid/orthophthalic acid (=50/50 by molar ratio), and the like. The number-average molecular weight of these is preferably 800 to 10,000, more preferably 1,000 to 4,000, and most preferably 1,500 to 3,000.

In addition to (J1), the polyester diol component (J) may comprise the following polyester diol (K). The content of (K) based on the total weight of (J) is, from the standpoint of a balance between tensile strength and elongation, preferably 0 to 95 weight %, more preferably 50 to 90 weight %, and most preferably 60 to 80 weight %.

The polyester diol (K) includes the following (K1) and (K2).

The polyester diol (K1) includes a polyester diol obtained from an aliphatic dicarboxylic acid and an aliphatic diol. Specific examples of the aliphatic dicarboxylic acid include aliphatic dicarboxylic acid having 4 to 10 carbon atoms (succinic acid, adipic acid, sebacic acid, glutaric acid, suberic acid, azelaic acid, maleic acid, fumaric acid, and the like) and specific examples of the aliphatic diol include aliphatic diols having 2 to 8 carbon atoms (ethylene glycol, diethylene glycol, 1,3-propanediol, 1,4-butanediol, 1,5-pentanediol, 1,6-hexanediol, and the like).

Among (K1), preferable are polyethylene adipate, polytetramethylene adipate, and polyhexamethylene adipate.

The polyester diol (K2) includes a polyester diol obtained by polymerizing a lactone monomer (lactones having 4 to 12 carbon atoms such as, for example, γ-butyrolactone, γ-valerolactone, ε-caplolactone, and a mixture of two or more of these).

The diisocyanate component (F) which constitutes the thermoplastic polyurethane resin includes:

(i) aliphatic diisocyanates having 2 to 18 carbon atoms (except the carbon atom in the NCO group; hereinafter, the same shall apply) [ethylene diisocyanate, tetramethylene diisocyanate, hexamethylene diisocyanate (HDI), dodecamethylene diisocyanate, 2,2,4-trimethylhexamethylene diisocyanate, lysine diisocyanate, 2,6-diisocyanatomethyl caproate, bis(2-isocyanatoethyl)fumarate, bis(2-isocyanatoethyl) carbonate, 2-isocyanatoethyl 2,6-diisocyanatohexanoate, and the like];

(ii) alicyclic diisocyanates having 4 to 15 carbon atoms [isophorone diisocyanate (IPDI), dicyclohexylmethane 4,4’-diisocyanate (hydrogenated MDI), cyclohexylene diisocyanate, methylcyclohexylene diisocyanate (hydrogenated TDI), bis(2-isocyanatoethyl)-4-cyclohexene, and the like];

(iii) araliphatic diisocyanates having 8 to 15 carbon atoms [m- and/or p-xylylene diisocyanate (XDI), α,α,α′,α′-tetramethylxylylene diisocyanate (TMXDI), and the like];

(iv) aromatic polyisocyanates [1,3- and/or 1,4-phenylene diisocyanate, 2,4- and/or 2,6-tolylene diisocyanate (TDI), crude TDI, 2,4′- and/or 4,4′-diphenylmethane diisocyanate (MDI), 4,4′-diisocyanatobiphenyl, 3,3′-dimethyl-4,4′-diisocyanatobiphenyl, 3,3′-dimethyl-4,4′-diisocyanatodiphenylmethane, crude MDI, 1,5-naphthylene diisocyanate, 4,4′,4″-triphenylmethane triisocyanate, m- and p-isocyanatophenylsulfonyl isocyanate, and the like];

(v) modified products of these diisocyanates (modified products of diisocyanates having carbodiimide groups, uretdione groups, uretimine groups, urea groups, and the like); and mixtures of two or more of these.

Preferable among these are the aliphatic diisocyanates or the alicyclic diisocyanates, and especially preferable are HDI, IPDI, and hydrogenated MDI.

The thermoplastic polyurethane resin particles (A) can be produced, for example, by the following process.

In the presence of water and a dispersion stabilizer, a ketimine compound of a diamine, which is a chain-extender, is hydrolyzed in water to yield a diamine, and the diamine and a urethane prepolymer having terminal isocyanate groups are reacted to obtain a polyurethane resin.

The reaction temperature at which an isocyanate-terminated urethane prepolymer is produced may be the same as the temperature usually employed when carrying out urethanization. When a solvent is employed, the reaction temperature is usually 20° C. to 100° C. and, when a solvent is not used, the reaction temperature is usually 20° C. to 220° C., and preferably 80° C. to 200° C. By reacting the polyester diol component (J) and the diisocyanate component (F) so that the molar ratio of the hydroxyl group and the isocyanate group becomes 1:1.2 to 1:1.6, the isocyanate-terminated urethane prepolymer can be obtained.

The chain extension reaction is preferably carried out at 20 to 120° C. for 1 to 20 hours, and the equivalent ratio of the terminal isocyanate of the urethane prepolymer and the diamine is preferably 1:0.8 to 1:1.2.

As the dispersion stabilizer, preferable are anionic, nonionic, and cationic dispersants, and more preferable are the anionic ones. Examples of the dispersion stabilizer include, for example, a metal salt of a copolymer of an unsaturated carboxylic acid and an olefin, and the like.

Subsequently, a dispersion obtained is filtered and dried to obtain the thermoplastic polyurethane resin particles (A). Specifically, for example, there can be used those obtained by a process described in JP-A No. H8-120041 and the like.

The resin particles (A) can also be produced by a process where the above-described isocyanate-terminated urethane prepolymer is subjected to a chain extension reaction in the presence of a nonpolar organic solvent and a dispersion stabilizer.

In the perfectly spherical thermoplastic polyurethane resin particles (A), the term “perfectly spherical” is defined to mean particles having a shape factor, SF2, of 100 to 115.

Such polyurethane particles can be obtained, for example, by using a process for production of a perfectly spherical resin particle dispersion (the process described in Japanese Patent No. 4289720), comprising: feeding a liquid dispersion phase comprising an isocyanate-terminated polyurethane prepolymer and a dispersion medium comprising only water or a combination of water and one or more selected from the group consisting of alcohols, dimethyl formamide, tetrahydrofuran, cellosolves, and lower ketones; dispersing the above by high-speed rotation of an agitating blade; and, at the same time, reacting the urethane prepolymer with a curing agent (a ketimine compound).

The shape factor, SF2, indicates a proportion of irregularity in the shape of a particle. It is a value represented by the following Equation (2), obtained by dividing a square of a perimeter, PERI, of a figure formed when the particle is projected on a two-dimensional plane by the area of the figure, AREA, and multiplying the result by 100/4π:

SF2={(PERI)²/(AREA)}×(100/4π) (2)

As the value of SF2 becomes larger, the irregularity of the surface of the urethane particle becomes more pronounced.

Measurement of the shape factor includes a method where a picture of a particle is taken by a scanning electron microscope (S-800: manufactured by Hitachi, Ltd.) and the picture is analyzed by introduction into an image analyzer (LUSEX 3: manufactured by NIRECO Corporation); a method where the measurement is made by using a flow particle image analyzer (FPIA-3000: manufactured by Sysmex Corporation); and the like.

The plasticizer (B) includes phthalic acid esters (dibutyl phthalate, dioctyl phthalate, dibutylbenzyl phthalate, diisodecyl phthalate, and the like); aliphatic dibasic acid esters (di-2-ethylhexyl adipate, 2-ethylhexyl sebacate, and the like); trimellitic acid esters (tri-2-ethylhexyl trimellitate, trioctyl trimellitate, and the like); aliphatic acid esters (butyl oleate and the like); benzoic acid esters [dibenzoate of polyethylene glycol (degree of polymerization: 2 to 10), dibenzoate of polypropylene glycol (degree of polymerization: 2 to 10), and the like]; aliphatic phosphoric acid esters (trimethyl phosphate, triethyl phosphate, tributyl phosphate, tri-2-ethylhexyl phosphate, tributoxy phosphate, and the like); aromatic phosphoric acid esters [triphenyl phosphate, tricresyl phosphate, trixylenyl phosphate, cresyldiphenyl phosphate, xyleneyldiphenyl phosphate, 2-ethylhexyldiphenyl phosphate, tris(2,6-dimethylphenyl)phosphate, and the like]; halogenated aliphatic phosphoric acid esters [tris(chloroethyl)phosphate, tris(β-chloropropyl)phosphate, tris(dichloropropyl)phosphate, tris(tribromoneopentyl)phosphate, and the like]; and mixtures of two or more of these.

The content of the plasticizer (B) relative to the thermoplastic polyurethane resin particles (A) is, from the standpoint of elongation, preferably 1 to 30 weight %, more preferably 3 to 20 weight %, and most preferably 5 to 10 weight %.

The vinyl-type copolymer fine particles (C) having a crosslinked structure, which are used in the present invention, have a crosslinked structure to an extent that they become insoluble at a temperature of the slush molding.

The fine particles (C) include, for example, a copolymer of an alkyl(meth)acrylate and a polyfunctional (meth)acrylate of a polyhydric alcohol.

The alkyl(meth)acrylate includes an alkyl(meth)acrylate having an alkyl group having 1 to 50 carbon atoms, for example, methyl(meth)acrylate, ethyl(meth)acrylate, propyl(meth)acrylate, butyl(meth)acrylate, 2-ethylhexyl(meth)acrylate, dodecyl(meth)acrylate, hexadecyl(meth)acrylate, heptadecyl(meth)acrylate, eicosyl(meth)acrylate, and the like.

The polyfunctional (meth)acrylate of a polyhydric alcohol includes ethylene glycol di(meth)acrylate, propylene glycol di(meth)acrylate, 1,3-butylene di(meth)acrylate, neopentyl glycol di(meth)acrylate, trimethylolpropane tri(meth)acrylate, polyethylene glycol di(meth)acrylate, and the like.

Among these, from the standpoint of compatibility with urethane resins, preferable is a copolymer of methyl methacrylate and ethylene glycol dimethacrylate.

From the standpoint of controlling the extent of surface coverage to 20 to 80%, the content of the vinyl-type copolymer fine particles (C) having a crosslinked structure, relative to 100 weight parts of the thermoplastic polyurethane resin particles (A), is, for example, 0.1 to 0.8 weight part when the primary particle size of the vinyl-type copolymer fine particle (C) is 50 to 200 nm; 0.2 to 1.3 weight parts when the primary particle size of (C) is 200 to 300 nm; 0.2 to 1.7 weight parts when the primary particle size of (C) is 300 to 400 nm; and 0.3 to 2.1 weight parts when the primary particle size of (C) is 400 to 500 nm.

The volume average particle size of the above-described (C) is, from the standpoints of an effect of decreasing the degree of elongation of the molded article and fluidity (powder flowability) of the resin powder composition, preferably 50 to 500 nm, more preferably 80 to 400 nm, and most preferably 100 to 300 nm.

The shape of the above-described (C) is not particularly limited, but from the aspect of material flowability at the time of molding, it is desirably spherical or close to it.

A ratio of the volume average particle sizes of the thermoplastic polyurethane resin particles (A) and the vinyl-type copolymer fine particles (C) having a cross-linked structure of the present invention, (A):(C), is preferably 200:1 to 2000:1, and more preferably 400:1 to 1900 to 1. This range is preferable in that, within the range, it becomes easy to control the extent of surface coverage in the mixed particles of (A) and (C) between 20 to 80%.

Here, the volume average particle size refers to a value of the particle size corresponding to 50% passing as measured by a laser diffraction/scattering particle size/particle size distribution measuring apparatus (hereinafter described as the particle size analyzer).

With regard to the measurement method, a 20 g sample of particles is added to 100 ml of a 2% aqueous solution of SANSPEARL PS-8 (produced by Sanyo Chemical Ind., Ltd.) and the mixture is stirred for 5 minutes or more. A sample of 0.3 to 0.5 ml is taken out and loaded on the particle size analyzer, and the particle size distribution is measured. The measuring apparatus includes, for example, Microtrack HRA Particle Size Analyzer 9320-X100 (manufactured by Nikkiso Co., Ltd.) and the like.

In the polyurethane resin powder composition (D) for slush molding of the present invention, the surface of the perfectly spherical thermoplastic polyurethane resin particles (A) contained therein is covered with the vinyl copolymer fine particles (C) having a crosslinked structure, wherein the extent of surface coverage is 20 to 80%.

The above-described extent of surface coverage of the surface of the (A) with (C) is obtained from the following Equation (1).

$$\begin{matrix} [ Expression 2 ] & \\ Extent of surface coverage ( \% ) = \frac{\begin{matrix}[ number of particles of ( C ) ] \times \\ [ average cross section of one particle of ( C ) ]\end{matrix}}{surface area of ( A )} \times 100 & ( 1 )\end{matrix}$$

In the above-described Equation (1), the number of particles of (C) is calculated by dividing the amount (weight) of (C) added by a product of an average volume of one particle of (C), obtained as described below, and true specific gravity of (C). The average volume of one particle of (C) and the average cross section area of one particle of (C) are calculated from a radius of a primary particle of (C), the radius being determined by observing (C), which has been crushed to primary particles, with a scanning electron microscope. The radius of the primary particle of (C) is calculated by magnifying the particles by means of a scanning electron microscope to such an extent that the size of one particle can be observed, selecting about 50 particles randomly and measuring radii thereof, and computing the average of these values.

To crush (C), it is only necessary, for example, to add a small amount of (C) to (A) and to mix them for about 5 minutes by a coffee mill and the like.

The surface area of (A) is obtained by dividing a particle size distribution obtained by a particle size analyzer into 30 to 60 sections, calculating the surface areas of (A) for respective divided sections from the particle size and a frequency obtained from a center value of distribution for each divided section, and calculating the surface area of (A) from a sum of these surface areas.

When the extent of surface coverage of the surface of (A) with (C) is less than 20%, the effect of decreasing elongation is small and the degree of elongation of the outer skin becomes 600% or more, resulting in occurrence of a trouble at the time of airbag deployment. When the extent of coverage exceeds 80%, the vinyl copolymer fine particles which do not dissolve at the molding temperature become the fracture points, resulting in weaker strength of the polyurethane resin and occurrence of a trouble that, at the time of airbag deployment, the airbag deploys from a position other than the rupture opening. The extent of surface coverage is 20 to 80%, and preferably 30 to 50%.

The polyurethane resin powder composition (D) for slush molding of the present invention is obtained by a process comprising impregnating the thermoplastic polyurethane resin particles (A) with the plasticizer (B), thereafter cooling the particles, and adding thereto at room temperature the vinyl-type copolymer fine particles (C) having a crosslinked structure.

The primary particle size of (C) contributes significantly to the additive amount of (C) to cover (A). For example, (D) can be produced by adding 0.1 to 0.8 weight part of (C) relative to 100 weight parts of (A), when the primary particle size of the vinyl-type copolymer fine particles (C) is 50 to 200 nm; adding 0.2 to 1.3 weight parts of (C) relative to 100 weight parts of (A), when the primary particle size of the vinyl-type copolymer fine particles (C) is 200 to 300 nm; adding 0.2 to 1.7 weight parts of (C) relative to 100 weight parts of (A), when the primary particle size of the vinyl copolymer fine particles (C) is 300 to 400 nm; and adding 0.3 to 2.1 weight parts of (C) relative to 100 weight parts of (A), when the primary particle size of the vinyl-type copolymer fine particles (C) is 400 to 500 nm.

In order to cover the surface of the urethane resin particles with above-described (C) to the extent of 20 to 80%, it is preferable to stir the particles at a peripheral speed of an impeller of 1.0 to 2.2 m/sec by the under-mentioned mixing apparatus.

The polyurethane resin powder composition (D) for slush molding of the present invention may comprise an additive (G) in addition to the thermoplastic polyurethane resin particles (A), the plasticizer (B), and the vinyl-type copolymer fine particles (C). The content of (G), relative to 100 weight parts of (A), is 0 to 50 weight parts.

As (G), there may be mentioned an inorganic filler, a pigment, a demolding agent, a stabilizer, an antiblocking agent, a dispersant, and the like.

The inorganic filler includes kaolin, talc, silica, titanium oxide, calcium carbonate, bentonite, mica, sericite, glass flake, glass fiber, graphite, magnesium hydroxide, aluminum hydroxide, antimony trioxide, barium sulfate, zinc borate, alumina, magnesia, wollastonite, xonotlite, whisker, metal powder, and the like. Among these, from the standpoint of enhancing crystallization of a thermoplastic resin, preferable are kaolin, talc, silica, titanium oxide, and calcium carbonate, and more preferable are kaolin and talc.

The volume average particle size (μm) of the inorganic filler is, from the standpoint of dispersibility in the thermoplastic polyurethane resin particles (A), preferably 0.1 to 30, more preferably 1 to 20, and especially preferably 5 to 10.

The additive amount of the inorganic filler, relative to 100 weight parts of (A), is preferably 0 to 40 weight parts, and more preferably 1 to 20 weight parts.

The pigment particles are not particularly limited and there can be used heretofore known organic pigments and/or inorganic pigments. These are blended, relative to 100 weight parts of (A), usually in an amount of 10 weight parts or less, and preferably in an amount of 0.01 to 5 weight parts. The organic pigments include, for example, insoluble or soluble azo pigments, copper phthalocyanine-type pigments, quinacridone-type pigments, and the like. The inorganic pigments include, for example, chromates, ferrocyanide compounds, metal oxides (titanium oxide, iron oxide, zinc oxide, aluminum oxide, and the like), metal salts [sulfates (barium sulfate and the like), silicates (calcium silicate, magnesium silicate, and the like), carbonates (calcium carbonate, magnesium carbonate, and the like), phosphates (calcium phosphate, magnesium phosphate, and the like), and the like], metal powder (aluminum powder, iron powder, nickel powder, copper powder, and the like), carbon black, and the like. The volume average particle size of the pigments is not particularly limited but it is usually 0.2 to 5.0 μm, and preferably 0.5 to 1 μm.

The additive amount of the pigment particles, relative to 100 parts by weight of (A), is preferably 0 to 5 weight parts, and more preferably 1 to 3 weight parts.

As the demolding agent, there can be used heretofore known demolding agents and the like. Included are fluorine compound-type demolding agents [phosphoric acid triperfluoroalkyl (having 8 to 20 carbon atoms) esters, for example, triperfluorooctyl phosphate, triperfluorododecyl phosphate, and the like]; silicone compound-type demolding agents (dimethylpolysiloxane, amino-modified dimethylpolysiloxane, carboxyl-modified dimethylpolysiloxane, and the like); fatty acid ester-type demolding agents (mono- or poly-hydric alcohol esters of fatty acids having 10 to 24 carbon atoms, for example, butyl stearate, hardened castor oil, ethylene glycol monostearate, and the like); fatty acid amide-type demolding agents (mono- or bis-amides of fatty acids having to 24 carbon atoms, for example, oleic amide, palmitic amide, stearyl amide, ethylenediamine-distearic acid amide, and the like); metal soaps (magnesium stearate, zinc stearate, and the like); natural or synthetic waxes (paraffin wax, microcrystalline wax, polyethylene wax, polypropylene wax, and the like); mixtures of two or more of these; and the like.

The additive amount of the demolding agent, relative to 100 weight parts of (A), is preferably 0 to 1 weight part, and more preferably 0.1 to 0.5 weight part.

As the stabilizer, there can be used a compound having in the molecule a carbon-carbon double bond (an ethylene bond and the like, which may have a substituent) (excluding, however, double bonds in the aromatic ring), a carbon-carbon triple bond (an acetylene bond, which may have a substituent), or the like. Included are esters of (meth)acrylic acid and polyhydric alcohols (2- to 10-valent polyhydric alcohols; hereinafter, the same shall apply) [ethylene glycol di(meth)acrylate, trimethylolpropane tri(meth)acrylate, pentaerythritol tetra(meth)acrylate, dipentaerythritol tri(meth)acrylate, and the like]; esters of (meth)allyl alcohol and 2- to 6-valent polybasic carboxylic acids (diallyl phthalate, triallyl trimellitate, and the like); poly(meth)allyl ethers of polyhydric alcohols [pentaerythritol(meth)allyl ether and the like]; polyvinyl ethers of polyhydric alcohols (ethylene glycol divinyl ether and the like); polypropenyl ethers of polyhydric alcohols (ethylene glycol dipropenyl ether and the like); polyvinylbenzene (divinylbenzene and the like); mixtures of two or more of these; and the like.

Among these, from the standpoint of stability (radical polymerization rate), preferable are esters of (meth)acrylic acid and polyhydric alcohols, and more preferable are trimethylolpropane tri(meth)acrylate, pentaerythritol tetra(meth)acrylate, and dipentaerythritol penta(meth)acrylate.

The additive amount of the stabilizer, relative to 100 weight parts of (A), is preferably 0 to 20 weight parts, and more preferably 1 to 15 weight parts.

In the polyurethane resin powder composition (D) for slush molding of the present invention, there can be used, as a powder fluidity improver and an antiblocking agent, heretofore known inorganic antiblocking agents, organic antiblocking agents, and the like. The inorganic antiblocking agents include silica, talc, titanium oxide, calcium carbonate, and the like. The organic antiblocking agents include thermosetting resins having a particle size of 10 μm or less (thermosetting polyurethane resins, guanamine-type resins, epoxy-type resins, and the like) and thermoplastic resins having a particle size of 10 μm or less [thermoplastic polyurethane urea resins, poly(meth)acrylate resins, and the like], and the like.

The additive amount of the antiblocking agent (fluidity improver), relative to 100 weight parts of (A), is preferably 0 to 5 weight parts, and more preferably 0.2 to 1 weight part.

As the mixing apparatus used when manufacturing the polyurethane resin powder composition (D) for slush molding, there can be used heretofore known powder mixing apparatuses, including any of rotating container-type mixers, fixed container-type mixers, and hydrokinetic mixers. For example, there is well known a process to dry blend powders by using, as a fixed container-type mixer, a high-speed flow mixer, a multi-shaft paddle-type mixer, a high-speed shearing mixing apparatus [Henschel Mixer (registered trade mark) and the like], a low-speed mixing apparatus (planetary mixer and the like), or a cone-shaped screw mixer [Nauta Mixer (registered trademark) and the like]. Among these processes, it is preferable to use the multi-shaft paddle-type mixer, the low-speed mixing apparatus (planetary mixer and the like), and the cone-shaped screw mixer [Nauta Mixer (registered trademark; hereinafter this annotation will be omitted) and the like].

The volume average particle size of the thermoplastic polyurethane resin particles (A) of the present invention is usually 0.1 to 500 μm. However, in order for the effect of the present invention to be fully produced, it is preferably 10 to 300 μm, and more preferably 100 to 200 μm.

As an example of the polyurethane resin molded article obtained by molding the polyurethane resin powder composition (D) for slush molding of the present invention, there may, for example, be mentioned an outer skin obtained by slush molding the polyurethane resin powder composition (D) for slush molding. Slush molding can suitably be carried out, for example, by a method, comprising vibrating and rotating a box containing (D) and a heated mold together, melting and flowing (D) in the mold, and thereafter cooling and solidifying (D) to manufacture the outer skin.

Heretofore, the mold temperature when slush molding is carried out using a polyurethane resin powder composition for slush molding has been generally preferably 200 to 300° C., and more preferably 230 to 280° C. However, the polyurethane resin powder composition (D) for slush molding of the present invention can be molded at a lower temperature and the mold temperature is preferably 180 to 270° C., and more preferably 200 to 250° C.

The thickness of the outer skin is preferably 0.4 to 1.2 mm. The outer skin can be fabricated into a polyurethane resin molded article having the outer skin by setting the outer skin in the foaming mold so that its surface comes in contact with the mold and casting polyurethane foam to form a foam layer of 5 mm to 15 mm thickness on the rear side of the outer skin.

The polyurethane resin molded article of the present invention is suitably used for automotive interior materials, for example, instrument panels, door trims, and the like.

### EXAMPLES

Hereinafter, the present invention will be further described by way of examples; however, the present invention is not limited to these. In the following description, “part(s)” represents part(s) by weight.

### Production Example 1

### Production of an MEK Ketimine Compound of a Diamine

While refluxing hexamethylenediamine and excessive amount of MEK (methyl ethyl ketone, 4 times in mole relative to the amount of the diamine) at 80° C. for 24 hours, water generated was removed to the outside of the system. Then, under a reduced pressure, unreacted MEK was removed to obtain an MEK ketimine compound.

### Production Example 2

Production of Polyethylene Phthalate Diol (terephthalic acid/orthophthalic acid=50/50) (J1-1) of which number average molecular weight (hereinafter referred to as “Mn”) is 2500

Into a reaction vessel equipped with a condenser tube, a stirrer and a nitrogen-inlet tube were charged 393 parts of terephthalic acid, 393 parts of isophthalic acid and 606 parts of ethylene glycol, and under a nitrogen flow, a reaction was carried out for 5 hours at 210° C. removing generated water. Then, the reaction was performed under reduced pressure of 5 to 20 mmHg and polyethylene phthalate diol (J1-1) was taken out when it reached the specified softening point. The amount of recovered ethylene glycol was 270 parts. A hydroxyl value of the obtained polyethylene phthalate diol was measured and the Mn was calculated to be 2500.

### Production Example 3

### Production of Prepolymer Solution (U-1)

Into a reaction vessel equipped with a thermometer, a stirrer and a nitrogen-blowing tube were charged polyethylene phthalate diol (J1-1) (304 parts), polybutylene adipate (1216 parts) having an Mn of 1000 and 1-octanol (10 parts), and then the inside of the vessel was purged with nitrogen. Thereafter, while stirred, the mixture was heated to 110° C. to be melted, and then the mixture was cooled to 60° C. Subsequently, thereinto was charged hexamethylene diisocyanate (312 parts), and the reaction was performed at 85° C. for 10 hours. Next, after the system was cooled to 60° C., thereto were added tetrahydrofuran (336 parts), a stabilizer (4.5 parts) [IRGANOX 1010, manufactured by Ciba Specialty Chemicals Ltd.], and carbon black (50 parts). The components were mixed with each other evenly to obtain a prepolymer solution (U-1). The NCO content of the resultant prepolymer solution was 1.6 weight %.

### Production Example 4

### Production of Thermoplastic Polyurethane Resin Particles (A-1)

Into a reaction vessel were charged and mixed the prepolymer solution (U-1) obtained in the production example 3 (100 parts) and the MEK ketimine compound obtained in the production example 1 (0.7 parts), and thereto was added 300 parts of an aqueous solution in which a polycarboxylic acid type anionic surfactant (Sansparl PS-8, manufactured by Sanyo Chemical Ind., Ltd. (30 parts)) was dissolved. An Ultra Disperser manufactured by YAMATO Scientific Co., Ltd. was then used to mix these components at a rotation number of 6000 rpm for 1 minute. The mixture was then transferred to a reaction vessel equipped with a thermometer, a stirrer and a nitrogen blowing tube. After the inside of the vessel was purged with nitrogen, the reaction was performed under stirring at 50° C. for 10 hours. After the reaction was completed, the resultant was separated by filtration and dried to obtain thermoplastic polyurethane resin particles (A-1). The (A-1) had an Mn of 20000, a concentration of urea group of 2.6 weight % and a volume average particle size of 140 μm.

### Production Example 5

### Production of Thermoplastic Polyurethane Resin Particles (A-2)

Into a reaction vessel were charged and mixed the prepolymer solution (U-1) obtained in the production example 3 (100 parts) and the MEK ketimine compound obtained in the production example 1 (0.7 parts), and thereto was added 300 parts of an aqueous solution in which a polycarboxylic acid type anionic surfactant (Sansparl PS-8, manufactured by Sanyo Chemical Ind., Ltd. (30 parts)) was dissolved. An Ultra Disperser manufactured by YAMATO Scientific Co., Ltd. was then used to mix these components at a rotation number of 4000 rpm for 1 minute. The mixture was then transferred to a reaction vessel equipped with a thermometer, a stirrer and a nitrogen blowing tube. After the inside of the vessel was purged with nitrogen, the reaction was performed under stirring at 50° C. for 10 hours. After the reaction was completed, the resultant was separated by filtration and dried to obtain thermoplastic polyurethane resin particles (A-2). The (A-2) had an Mn of 20000, a concentration of urea group of 2.6 weight % and a volume average particle size of 190 μm.

### Production Example 6

### Production of Thermoplastic Polyurethane Resin Particles (A-3)

Into a reaction vessel were charged and mixed the prepolymer solution (U-1) obtained in the production example 3 (100 parts) and the MEK ketimine compound obtained in the production example 1 (0.7 parts), and thereto was added 300 parts of an aqueous solution in which a polycarboxylic acid type anionic surfactant (Sansparl PS-8, manufactured by Sanyo Chemical Ind., Ltd. (30 parts)) was dissolved. An Ultra Disperser manufactured by YAMATO Scientific Co., Ltd. was then used to mix these components at a rotation number of 10000 rpm for 1 minute. The mixture was then transferred to a reaction vessel equipped with a thermometer, a stirrer and a nitrogen blowing tube. After the inside of the vessel was purged with nitrogen, the reaction was performed under stirring at 50° C. for 10 hours. After the reaction was completed, the resultant was separated by filtration and dried to obtain thermoplastic polyurethane resin particles (A-3). The (A-3) had an Mn of 20000, a concentration of urea group of 2.6 weight % and a volume average particle size of 100 μm.

### Example 1

Into a 100L Nauta Mixer were charged 100 parts of the above described (A-1) and 10 parts of a polyethylene glycol dibenzoate [Sanflex EB300, manufactured by Sanyo Chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 0.22 part of fine particles of methyl methacrylate ethyleneglycol dimethacrylate copolymer [copolymerization ratio of 95:5 (ratio by weight), primary particle size of 300 nm; Ganz Pearl PM-030, manufactured by Ganz Chemical Co., Ltd.] (C-1), and the components were mixed at a peripheral speed of 1.0 m/s to obtain a polyurethane resin powder composition for slush molding (D-1). The extent of surface coverage of the (D-1) was 20% and the ratio of volume average particle size was 467. In addition, the polyurethane resin molded article obtained from the (D-1) had a degree of tensile elongation of 590% and a tensile strength of 9.0 MPa.

### Example 2

Into a 100 L Nauta Mixer were charged 100 parts of the above described (A-1) and 10 parts of a polyethylene glycol dibenzoate [Sanflex EB300, manufactured by Sanyo Chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 0.40 part of fine particles of methyl methacrylate-ethyleneglycol dimethacrylate copolymer [copolymerization ratio of 95:5 (ratio by weight), primary particle size of 300 nm; Ganz Pearl PM-030, manufactured by Ganz Chemical Co., Ltd.] (C-1), and the components were mixed at a peripheral speed of 1.0 m/s to obtain a polyurethane resin powder composition for slush molding (D-2). The extent of surface coverage of the (D-2) was 36% and the ratio of volume average particle size was 467. In addition, the polyurethane resin molded article obtained from the (D-2) had a degree of tensile elongation of 540% and a tensile strength of 8.2 MPa.

### Example 3

Into a 100 L Nauta Mixer were charged 100 parts of above described (A-1) and 10 parts of a polyethylene glycol dibenzoate [Sanflex EB300, manufactured by Sanyo Chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 0.20 part of fine particles of methyl methacrylate-ethyleneglycol dimethacrylate copolymer [copolymerization ratio of 95:5 (ratio by weight), primary particle size of 100 nm; Ganz Pearl PM-010J, manufactured by Ganz Chemical Co., Ltd.] (C-2), and the components were mixed at a peripheral speed of 1.0 m/s to obtain a polyurethane resin powder composition for slush molding (D-3). The extent of surface coverage of the (D-3) was 55% and the ratio of volume average particle size was 1400. In addition, the polyurethane resin molded article obtained from the (D-3) had a degree of tensile elongation of 500% and a tensile strength of 7.6 MPa.

### Example 4

Into a 100 L Nauta Mixer were charged 100 parts of above described (A-1) and 10 parts of a polyethylene glycol dibenzoate [Sanflex EB300, manufactured by Sanyo Chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 0.29 part of fine particles of methyl methacrylate-ethyleneglycol dimethacrylate copolymer [copolymerization ratio of 95:5 (ratio by weight), primary particle size of 100 nm; Ganz Pearl PM-010J, manufactured by Ganz Chemical Co., Ltd.] (C-2), and the components were mixed at a peripheral speed of 1.0 m/s to obtain a polyurethane resin powder composition for slush molding (D-4). The extent of surface coverage of the (D-4) was 79% and the ratio of volume average particle size was 1400. In addition, the polyurethane resin molded article obtained from the (D-4) had a degree of tensile elongation of 450% and a tensile strength of 7.1 MPa.

### Example 5

Into a 100 L Nauta Mixer were charged 100 parts of above described (A-2) and 10 parts of a polyethylene glycol dibenzoate [Sanflex EB300, manufactured by Sanyo Chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 0.20 part of fine particles of methyl methacrylate-ethyleneglycol dimethacrylate copolymer [copolymerization ratio of 95:5 (ratio by weight), primary particle size of 300 nm; Ganz Pearl PM-030, manufactured by Ganz Chemical Co., Ltd.] (C-1), and the components were mixed at a peripheral speed of 1.0 m/s to obtain a polyurethane resin powder composition for slush molding (D-5). The extent of surface coverage of the (D-5) was 23% and the ratio of volume average particle size was 633. In addition, the polyurethane resin molded article obtained from the (D-5) had a degree of tensile elongation of 580% and a tensile strength of 8.8 MPa.

### Example 6

Into a 100 L Nauta Mixer were charged 100 parts of above described (A-2) and 10 parts of a polyethylene glycol dibenzoate [Sanflex EB300, manufactured by Sanyo chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 0.40 part of fine particles of methyl methacrylate-ethyleneglycol dimethacrylate copolymer [copolymerization ratio of 95:5 (ratio by weight), primary particle size of 300 nm; Ganz Pearl PM-030, manufactured by Ganz Chemical Co., Ltd.] (C-1), and the components were mixed at a peripheral speed of 1.0 m/s to obtain a polyurethane resin powder composition for slush molding (D-6). The extent of surface coverage of the (D-6) was 46% and the ratio of volume average particle size was 633. In addition, the polyurethane resin molded article obtained from the (D-6) had a degree of tensile elongation of 520% and a tensile strength of 8.0 MPa.

### Example 7

Into a 100 L Nauta Mixer were charged 100 parts of above described (A-2) and 10 parts of a polyethylene glycol dibenzoate [Sanflex EB300, manufactured by Sanyo chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 0.20 part of fine particles of methyl methacrylate-ethyleneglycol dimethacrylate copolymer [copolymerization ratio of 95:5 (ratio by weight), primary particle size of 100 nm; Ganz Pearl PM-010J, manufactured by Ganz Chemical Co., Ltd.] (C-2), and the components were mixed at a peripheral speed of 1.0 m/s to obtain a polyurethane resin powder composition for slush molding (D-7). The extent of surface coverage of the (D-7) was 69% and the ratio of volume average particle size was 1900. In addition, the polyurethane resin molded article obtained from the (D-7) had a degree of tensile elongation of 490% and a tensile strength of 7.6 MPa.

### Example 8

Into a 100 L Nauta Mixer were charged 100 parts of above described (A-2) and 10 parts of a polyethylene glycol dibenzoate [Sanflex EB300, manufactured by Sanyo chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 0.20 part of fine particles of methyl methacrylate-ethyleneglycol dimethacrylate copolymer [copolymerization ratio of 95:5 (ratio by weight), primary particle size of 100 nm; Ganz Pearl PM-010J, manufactured by Ganz Chemical Co., Ltd.] (C-2), and the components were mixed at a peripheral speed of 2.2 m/s to obtain a polyurethane resin powder composition for slush molding (D-8). The extent of surface coverage of the (D-8) was 69% and the ratio of volume average particle size was 1900. In addition, the polyurethane resin molded article obtained from the (D-8) had a degree of tensile elongation of 490% and a tensile strength of 7.5 MPa.

### Example 9

Into a 100 L Nauta Mixer were charged 100 parts of above described (A-3) and 10 parts of a polyethylene glycol dibenzoate [Sanflex EB300, manufactured by Sanyo chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 0.40 part of fine particles of methyl methacrylate-ethyleneglycol dimethacrylate copolymer [copolymerization ratio of 95:5 (ratio by weight), primary particle size of 300 nm; Ganz Pearl PM-030, manufactured by Ganz Chemical Co., Ltd.] (C-1), and the components were mixed at a peripheral speed of 1.0 m/s to obtain a polyurethane resin powder composition for slush molding (D-9). The extent of surface coverage of the (D-9) was 24% and the ratio of volume average particle size was 333. In addition, the polyurethane resin molded article obtained from the (D-9) had a degree of tensile elongation of 580% and a tensile strength of 8.9 MPa.

### Comparative Example 1

Into a 100 L Nauta Mixer were charged 100 parts of above described (A-1) and 10 parts of a polyethylene glycol dibenzoate [Sanflex EB300, manufactured by Sanyo chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 0.20 part of a fine particle of methyl methacrylate-ethyleneglycol dimethacrylate copolymer [copolymerization ratio of 95:5 (ratio by weight), primary particle size of 300 nm; Ganz Pearl PM-030, manufactured by Ganz Chemical Co., Ltd.] (C-1), and the components were mixed at a peripheral speed of 1.0 m/s to obtain a polyurethane resin powder composition for slush molding (D-1′). The extent of surface coverage of the (D-1′) was 18% and the ratio of volume average particle size was 467. In addition, the polyurethane resin molded article obtained from the (D-1′) had a degree of tensile elongation of 620% and a tensile strength of 9.2 MPa.

### Comparative Example 2

Into a 100 L Nauta Mixer were charged 100 parts of above described (A-2) and 10 parts of a polyethylene glycol dibenzoate [Sanflex EB300, manufactured by Sanyo chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 0.75 part of a fine particle of methyl methacrylate-ethyleneglycol dimethacrylate copolymer [copolymerization ratio of 95:5 (ratio by weight), primary particle size of 300 nm; Ganz Pearl PM-030, manufactured by Ganz Chemical Co., Ltd.] (C-1), and the components were mixed at a peripheral speed of 1.0 m/s to obtain a polyurethane resin powder composition for slush molding (D-2′). The extent of surface coverage of the (D-2′) was 86% and the ratio of volume average particle size was 633. In addition, the polyurethane resin molded article obtained from the (D-2′) had a degree of tensile elongation of 350% and a tensile strength of 4.8 MPa.

### Comparative Example 3

Into a 100 L Nauta Mixer were charged 100 parts of above described (A-2) and 10 parts of a polyethylene glycol dibenzoate [Sanflex EB300, manufactured by Sanyo chemical Industries, Ltd.], and then these components were mixed at 70° C. for 3 hours. Then, there was charged 0.1 part of a modified polydimethylsiloxane [KF96, manufactured by Shin-Etsu Chemical Co., Ltd.] and after 1 hour of mixing, it was cooled to room temperature. Then thereto was added 1.00 part of a silica [primary particle size of 3000 nm; Ciblock S200, manufactured by Grace Japan Co., Ltd.] (G-1), and the components were mixed at a peripheral speed of 1.0 m/s to obtain a polyurethane resin powder composition for slush molding (D-3′). The polyurethane resin molded article obtained from the (D-3′) had a degree of tensile elongation of 240% and a tensile strength of 3.5 MPa.

The composition ratio of the polyurethane resin powder composition of Examples 1 to 9 and Comparative Examples 1 to 3, volume average particle size, extent of surface coverage and peripheral speed of impeller at the time of mixing (A) and (C), are shown in Table 1.

TABLE 1

| | | | Example | | | | | | | | | Comparative Example | | |
|---|---|---|---|---|---|---|---|---|---|---|---|---|---|---|
| | | | 1 | 2 | 3 | 4 | 5 | 6 | 7 | 8 | 9 | 1 | 2 | 3 |
| Polyurethane resin powder composition | | | D-1 | D-2 | D-3 | D-4 | D-5 | D-6 | D-7 | D-8 | D-9 | D-1′ | D-2′ | D-3′ |
| for slush molding (D) | | | | | | | | | | | | | | |
| Plasticizer (B) | EB-300 | Composition | 10 | 10 | 10 | 10 | 10 | 10 | 10 | 10 | 10 | 10 | 10 | 10 |
| Demolding agent | KF-96 | (parts) | 0.1 | 0.1 | 0.1 | 0.1 | 0.1 | 0.1 | 0.1 | 0.1 | 0.1 | 0.1 | 0.1 | 0.1 |
| Thermoplastic | A-1 | | 100 | 100 | 100 | 100 | | | | | | 100 | | |
| polyurethane resin | A-2 | | | | | | 100 | 100 | 100 | 100 | | | 100 | 100 |
| particles (A) | A-3 | | | | | | | | | | 100 | | | |
| Vinyl-type | C-1 | | 0.22 | 0.40 | | | 0.20 | 0.40 | | | 0.40 | 0.20 | 0.75 | |
| copolymer fine | C-2 | | | | 0.20 | 0.29 | | | 0.20 | 0.20 | | | | |
| particles (C) | | | | | | | | | | | | | | |
| Inorganic filler | G-1 | | | | | | | | | | | | | 1.00 |
| (Silica) | | | | | | | | | | | | | | |
| Thermoplastic | A-1 | Volume average | 140 | 140 | 140 | 140 | | | | | | 140 | | |
| polyurethane resin | A-2 | particle size | | | | | 190 | 190 | 190 | 190 | | | 190 | 190 |
| particles (A) | A-3 | (μm) | | | | | | | | | 100 | | | |
| Vinyl-type | C-1 | Primary | 300 | 300 | | | 300 | 300 | | | 300 | 300 | 300 | |
| copolymer fine | C-2 | particle size | | | 100 | 100 | | | 100 | 100 | | | | |
| particles (C) | | (nm) | | | | | | | | | | | | |
| Inorganic filler | G-1 | | | | | | | | | | | | | 3000 |
| (Silica) | | | | | | | | | | | | | | |

| | | | | | | | | | | | | |
|---|---|---|---|---|---|---|---|---|---|---|---|---|
| Ratio of volume average particle size | 467 | 467 | 1400 | 1400 | 633 | 633 | 1900 | 1900 | 333 | 467 | 633 | — |
| Extent of surface coverage (%) | 20 | 36 | 55 | 79 | 23 | 46 | 69 | 69 | 24 | 18 | 86 | — |
| peripheral speed (m/s) | 1.0 | 1.0 | 1.0 | 1.0 | 1.0 | 1.0 | 1.0 | 2.2 | 1.0 | 1.0 | 1.0 | 1.0 |
| Degree of tensile elongation (%) | 590 | 540 | 500 | 450 | 580 | 520 | 490 | 490 | 580 | 620 | 350 | 240 |
| Tensile strength (MPa) | 9.0 | 8.2 | 7.6 | 7.1 | 8.8 | 8.0 | 7.6 | 7.5 | 8.9 | 9.2 | 4.8 | 3.5 |

The extent of surface coverage of a surface of (A) with (C) was measured by the above described method.

The measurement of the radius of the primary particle of (C) was performed by using a scanning electron microscope (S-800: manufactured by HITACHI Ltd.) over 50 particles.

The surface area of (A) was calculated from the particle size distribution which is divided into 35 sections. The particle size distribution was obtained by using Microtrac HRA Particle Size Analyzer 9320-X100 (manufactured by Nikkiso Co., Ltd.) with 0.3 to 0.5 ml of the sample mixture prepared by charging 20 g of the particle sample into 100 ml of 2% aqueous solution of Sansparl PS-8 (manufactured by Sanyo Chemical Industries, Ltd.) and mixed for 5 minutes or more.

The calculated results of the extent of surface coverage are shown in Table 2.

TABLE 2

| | | | | | | | | | | | Comparative | |
|---|---|---|---|---|---|---|---|---|---|---|---|---|
| | | Example | | | | | | | | | Example | |
| | | 1 | 2 | 3 | 4 | 5 | 6 | 7 | 8 | 9 | 1 | 2 |
| Amount | parts | 0.22 | 0.40 | 0.20 | 0.29 | 0.20 | 0.40 | 0.20 | 0.20 | 0.40 | 0.20 | 0.75 |
| of (C) | by | | | | | | | | | | | |
| | weight | | | | | | | | | | | |
| True | | 1.20 | 1.20 | 1.20 | 1.20 | 1.20 | 1.20 | 1.20 | 1.20 | 1.20 | 1.20 | 1.20 |
| specific | | | | | | | | | | | | |
| gravity | | | | | | | | | | | | |
| of (C) | | | | | | | | | | | | |
| Primary | nm | 300 | 300 | 100 | 100 | 300 | 300 | 100 | 100 | 300 | 300 | 300 |
| particle | | | | | | | | | | | | |
| size of | | | | | | | | | | | | |
| (C) | | | | | | | | | | | | |
| Number | | 1.30 | 2.36 | 31.8 | 46.2 | 1.18 | 2.36 | 31.8 | 31.8 | 2.36 | 1.18 | 4.42 |
| of (C) | | | | | | | | | | | | |
| (×10¹³) | | | | | | | | | | | | |
| Average | cm² | 7.07 | 7.07 | 0.79 | 0.79 | 7.07 | 7.07 | 0.79 | 0.79 | 7.07 | 7.07 | 7.07 |
| cross | | | | | | | | | | | | |
| section | | | | | | | | | | | | |
| area | | | | | | | | | | | | |
| of (C) | | | | | | | | | | | | |
| (×10⁻¹⁰) | | | | | | | | | | | | |
| Surface | cm² | 45800 | 45800 | 45800 | 45800 | 36200 | 36200 | 36200 | 36200 | 68200 | 45800 | 36200 |
| area | | | | | | | | | | | | |
| of (A) | | | | | | | | | | | | |
| Extent | % | 20 | 36 | 55 | 79 | 23 | 46 | 69 | 69 | 24 | 18 | 86 |
| of | | | | | | | | | | | | |
| surface | | | | | | | | | | | | |
| cover- | | | | | | | | | | | | |
| age | | | | | | | | | | | | |

<The measurement of Degree of Tensile Elongation and Tensile Strength at 25° C.>

Three dumb bell test pieces No.1 according to JIS K6301 were punched out from the molded outer skin, and gauge lines of 40 mm interval were applied at the center of the each sample. The thickness was measured at the 5 points between gauge lines and the minimum value was adopted as the thickness. The sample was placed to an autograph in the atmosphere of 25° C., then the tensile test was performed at the tensile speed of 200 mm/min and the maximum degree of tensile elongation and the strength at break were calculated. If the tensile strength is 4.9 MPa or less, the possibility of rupturing at a position other than rupture openings increases upon airbag deployment.

### <Measurement Method of Number Average Molecular Weight>

The thermoplastic polyurethane resin particles were added to DMF so that the concentration of the thermoplastic polyurethane resin particles became 0.0125 weight %, stirred at 80° C. for 1 hour, filtered under pressure using a filter of 0.3 μm pore size. The thermoplastic polyurethane resin particles contained in the obtained filtrate was measured by a gel permeation chromatography using dimethylformamide as a solvent and polystyrene as a molecular weight standard.

The molded article obtained from the polyurethane resin powder compositions for slush molding (D-1) to (D-9) of the Examples 1 to 9 had the degree of tensile elongation of 600% or less and had the large tensile strength as well, revealing the excellence in the property upon airbag deployment. On the other hand, (D-1′) of the Comparative Example 1 had the degree of tensile elongation of 600% or more and (D-2′) of the Comparative Example 2 and (D-3′) of the Comparative Example 3 had small tensile strength.

### INDUSTRIAL APPLICABILITY

The molded article using the polyurethane resin powder composition for slush molding of the present invention, for example, outer skins can be suitably used as automotive interior materials, including outer skins for an instrument panel, a door trim and the like.

1. A polyurethane resin powder composition (D) for slush molding comprising perfectly spherical thermoplastic polyurethane resin particles (A) obtained by reacting a polyester diol component (J) and a diisocyanate component (F), a plasticizer (B), and a vinyl-type copolymer fine particles (C) having a crosslinked structure, wherein the polyester diol component (J) comprises a polyester diol (J1) comprising an aromatic dicarboxylic acid (E) and ethylene glycol as essential constituent units, a ratio of volume average particle sizes of (A) and (C), (A):(C), is 200:1 to 2000:1, and an extent of surface coverage of a surface of (A) with (C) {Equation (1)} is 20 to 80%.
$$\begin{matrix} [ Expression 1 ] & \\ Extent of surface coverage ( \% ) = \frac{\begin{matrix}[ number of particles of ( C ) ] \times \\ [ average cross section area of one part icl es of ( C ) ]\end{matrix}}{surface area of ( A )} \times 100 & ( 1 )\end{matrix}$$
[In the above-described Equation (1), the number of particles of (C) is calculated by dividing an additive amount (weight) of (C) by a product of average volume of one particle of (C), obtained as described below, and true specific gravity of (C). The average volume of one particle of (C) and the average cross section area of one particle of (C) are calculated from a radius of (C), the radius being determined by observing (C), which has been crushed to primary particles, with a scanning electron microscope. The surface areas of (A) is obtained by dividing a particle size distribution obtained by a particle size analyzer into 30 to 60 sections, calculating the surface area of (A) for respective divided sections from a particle size and a frequency obtained from a center value of distribution for each divided section, and calculating the surface area of (A) from a sum of these surface areas.]

2. The resin powder composition (D) according to claim 1, wherein the vinyl-type copolymer fine particles (C) are a copolymer of an alkyl(meth)acrylate and a polyfunctional (meth)acrylate of a polyhydric alcohol.

3. The resin powder composition (D) according to claim 1, wherein the vinyl-type copolymer fine particles (C) are a copolymer of methyl methacrylate and ethylene glycol dimethacrylate.

4. The resin powder composition (D) according to claim 1, wherein a volume average particle size of the vinyl-type copolymer fine particles (C) is 50 to 500 nm.

5. A process for producing the polyurethane resin powder composition (D) for slush molding according to claim 1, comprising the steps of: impregnating the thermoplastic polyurethane resin particles (A) with a plasticizer (B); thereafter adding the vinyl-type copolymer fine particles (C); and mixing the particles by stirring at a peripheral speed of an impeller of 1.0 to 2.2 m/sec until 20 to 80% of the surface of (A) becomes covered with (C).

6. A polyurethane resin molded article obtained by molding the polyurethane resin powder composition (D) for slush molding according to claim 1.

7. The polyurethane resin molded article according to claim 6, which is an automotive interior material.
